(19) United States
(12) Patent Application Publication
(10) Pub. No.: US 2017/0193519 A1
(43) Pub. Date: Jul. 6, 2017

(54) HUMAN RESOURCES CAPACITY PLANNING FOR NEW OPPORTUNITIES IN A CUSTOMER RELATIONSHIP MANAGEMENT (CRM) SYSTEM

(71) Applicant: SugarCRM Inc., Cupertino, CA (US)

(72) Inventor: Andy Murray, Sutton (GB)

(21) Appl. No.: 14/986,348

(22) Filed: Dec. 31, 2015

(51) Int. Cl. G06Q 30/00; G06Q 10/06

(52) U.S. Cl. CPC G06Q 30/01; G06Q 10/063112

(57) ABSTRACT

Embodiments of the invention provide a method, system and computer program product for human resources capacity planning for new opportunities in a customer relationship management (CRM) system. The method includes defining a business opportunity that includes data specifying an identity of a prospective customer, an identity of a prospective sale to the prospective customer and a date on which the business opportunity is created. The method also includes determining from the data required human resources to support the business opportunity and loading a real time pool of available human resources, and comparing the required human resources to the real time pool in order to compute whether or not the required human resources are available for assignment to the business opportunity. Finally, the method includes displaying in a user interface an indication of whether or not the required human resources are available for assignment to the business opportunity.

### BACKGROUND OF THE INVENTION

Field of the Invention

The present invention relates to CRM computing systems and more particularly to new business opportunity processing in a CRM computing system.

Description of the Related Art

The order entry component of a sales processing computing system typically incorporates inventory awareness during order entry such that an ordered quantity of goods can be satisfied by goods in inventory or goods expected to be in inventory, or in the alternative, such that a warning may be provided to the sales person or customer that a desired product is on backorder. Likewise, enterprise resource planning systems maintain inventoried component part awareness such that an ordered quantity of goods to be manufactured can be satisfied at build time from the requisite component parts present in inventory, or in the alternative so that an operator may be alerted to insufficient parts in inventory to build a desired product. In both instances, inventory awareness drives a determination of whether or not a product can be successfully delivered.

CRM computing systems do not incorporate order entry or enterprise resource planning. Rather, CRM computing systems largely focus upon opportunity management and the sales cycle in which an opportunity converts to a won sale or closes as a lost sale. Thus, an opportunity in a CRM computing system typically is defined in respect to one or more sales professionals necessary to convince a qualified prospect to purchase a product or a service. The process of introducing a new opportunity in a CRM computing environment differs from order entry or product build components in that in processing a new opportunity in a CRM computing environment, no dependency exists upon available inventory. Thus, there is no reason to impede the creation of a new opportunity in a CRM computing environment based upon available inventory.

Notwithstanding, resources are required to properly advance an opportunity from prospect to close. In particular, human resources are necessarily an integral component of the fulfillment of a purchase of services. Human resources requirements for a new opportunity can range from a single sales professional to a multiplicity of sales professionals, each fulfilling a discrete, albeit important role in the fulfillment of the purchase of services. To the extent that the human resources requisite to managing a prospect are not fully available, the opportunity for the prospect may be squandered.

### BRIEF SUMMARY OF THE INVENTION

Embodiments of the present invention address deficiencies of the art in respect to new business opportunity processing and provide a novel and non-obvious method, system and computer program product for human resources capacity planning for new opportunities in a CRM system. In an embodiment of the invention, a method for human resources capacity planning for new opportunities in a CRM system includes defining a business opportunity that includes data specifying an identity of a prospective customer, an identity of a prospective sale to the prospective customer and a date on which the business opportunity is created. The method also includes determining from the data required human resources to support the business opportunity and loading a real time pool of available human resources. The method yet further includes comparing the required human resources to the real time pool in order to compute whether or not the required human resources are available for assignment to the business opportunity. Finally, the method includes displaying in a user interface to the CRM application an indication of whether or not the required human resources are available for assignment to the business opportunity.

In one aspect of the embodiment, the required human resources are specified in terms of different required roles and wherein each of the available human resources in the pool are associated with a particular role. In another aspect of the embodiment, the required human resources are heuristically determined based upon past utilization of human resources for past processing of business opportunities in the CRM application. In yet another aspect of the embodiment, in response to a determination that the required human resources are not available for assignment to the business opportunity, a date is estimated when the required human resources are likely to be available for assignment to the business opportunity and the estimated date is included in the user interface.

In another embodiment of the invention, a CRM data processing system is configured for human resources capacity planning for new opportunities. The system includes a host computing system that includes one or more computers each with memory and at least one processor. The system also includes a CRM application executing in the host computing system. Finally, the system includes a human resources capacity planning module coupled to the CRM application. The module includes program code enabled upon execution in the host computing system to define a business opportunity in a data structure, the business opportunity comprising data specifying an identity of a prospective customer, an identity of a prospective sale to the prospective customer and a date on which the business opportunity is created, to determine from the data required human resources to support the business opportunity, to load into the memory of the host computing system from a data store of the CRM application a real time pool of available human resources, to compare in the memory of the host computing system the required human resources to the real time pool in order to compute whether or not the required human resources are available for assignment to the business opportunity and to display in a user interface to the CRM application an indication of whether or not the required human resources are available for assignment to the business opportunity.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for human resources capacity planning for new opportunities in a CRM system;

FIG. 2 is a schematic illustration of a CRM data processing system configured for human resources capacity planning for new opportunities; and,

FIG. 3 is a flow chart illustrating a process for human resources capacity planning for new opportunities in a CRM system.

### DETAILED DESCRIPTION OF THE INVENTION

Embodiments of the invention provide for human resources capacity planning for new opportunities in a CRM system. In accordance with an embodiment of the invention, a business opportunity can be recorded into a data structure in memory of a CRM data processing system. The business opportunity is defined in accordance with data including an identity of a prospective customer, a specification of the prospective order by the prospective customer, and a date upon which the business opportunity is recorded. Based upon the data, a specification of human resources is determined, for instance an identity of one or more different individuals or one or more different roles necessary to process the business opportunity. The specification is then compared to a real-time availability of individuals registered in the CRM data processing system in order to determine whether or not the specification of the human resources can be met by the real-time availability of the business opportunity. Finally, the determination is presented in a display of the CRM data processing system.

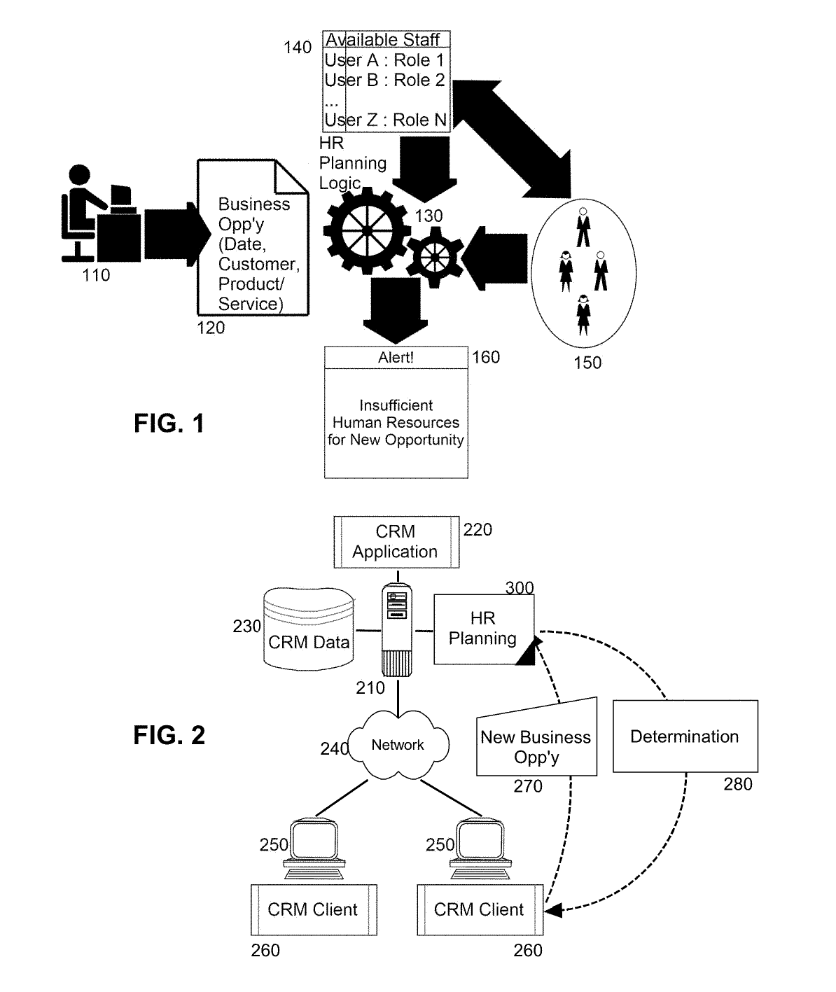

In further illustration, FIG. 1 pictorially shows a process for human resources capacity planning for new opportunities in a CRM system. As shown in FIG. 1, an end user 110 to a CRM system inputs a new business opportunity 120 into the CRM system. The new business opportunity 120 minimally includes data that identifies the date of the new business opportunity 120, a customer for the new business opportunity 120 and a product or service to be sold to the identified customer. !Human resources planning logic 130 extracts the data from the new business opportunity 120 and determines a set of required human resources 150 to appropriately process the business opportunity 120. The set of required human resources 150 can include the specific identity of different end users of the CRM application, or merely a specific set of roles of different end users of the CRM application.

In this regard, it can be predetermined that the sale of certain products or services requires a specific set of human resources—different individuals filling different roles within the selling organization. This predetermination can be heuristically determined based upon past processing of past business opportunities and either manually specified in a data structure stored in connection with the human resources planning logic 130, or programmatically specified based upon an observation of the assignment to past business opportunities both closed-won and closed-lost of different registered individuals of the CRM application and the corresponding roles of the individuals. A correlation is then programmatically determined between closed-won business opportunities and the number of individuals of particular roles assigned thereto. Likewise, a correlation is programmatically determined between closed-lost business opportunities and the number of individuals of particular roles assigned thereto.

In any event, once the set of required human resources 150 is determined for the new business opportunity 120, a real-time pool of available human resources 140 is retrieved for data storage in connection with the CRM application. The real-time pool 140 includes a list of individuals with adequate time availability to service the new business opportunity 120. Optionally, the real-time pool 140 also includes a list of individuals lacking adequate time to service the new business opportunity 120. As yet a further option, the real-time pool 140 includes a specification of when those in the list of individuals lacking adequate time are expected to become available to service the new business opportunity 120.

The human resource planning logic 130 compares the set of required human resources 150 to the real-time pool 140 in order to compute whether or not adequate human resources exist to service the new business opportunity 120. Consequently, the human resources planning logic 130 renders a user interface display for the end user 110 in the CRM application indicating whether or not adequate human resources exist to process the new business opportunity 120. In this way, the circumstance where inadequate human resources exist to properly service the new business opportunity can be detected at the outset of the new business opportunity 120 so as to avoid the spoliation of the new business opportunity 120.

The process described in connection with FIG. 1 is implemented in a CRM data processing system. In yet further illustration, FIG. 2 schematically shows a CRM data processing system configured for human resources capacity planning for new opportunities. The system includes a host computing system 210 that includes one or more computers each with memory and at least one processor (only a single representative computer shown for ease of illustration). The host computing system 210 supports the operation of a CRM application 220 providing CRM functionality to different CRM clients 260 executing in respectively different client computing devices 250 over computer communications network 240 and utilizing information stored in a CRM data store 230 coupled to the host computing system 210.

Of note, a human resources planning module 300 is coupled to the CRM application 220. The human resources planning module 300 includes program code that when executes in the host computing system 210, extracts data from a new business opportunity 270 in order to identify a set of human resources required to properly service the new business opportunity 270. The program code additionally is enabled upon execution in the host computing system 210 to compare the required set of human resources to a real-time pool of available human resources in order to compute whether or not the required set of human resources can be allocated to the new business opportunity 270. Finally, the program code is enabled to present the determination of whether or not the required set of human resources can be allocated to the new business opportunity in a user interface display 280 in the CRM client 260 from which the new business opportunity 270 had been input.

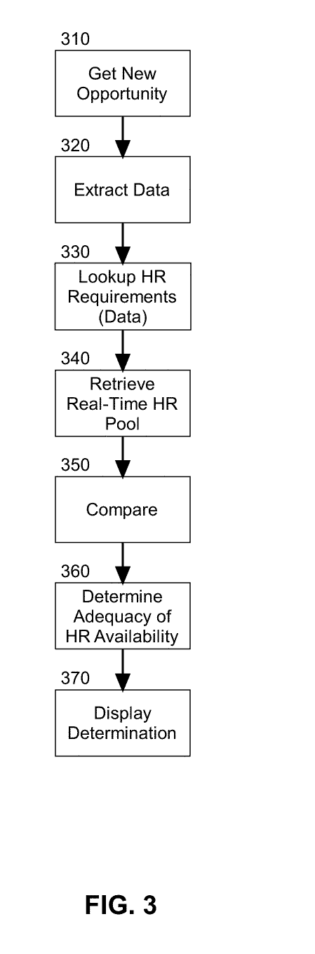

In even yet further illustration of the operation of the human resources planning module 300, FIG. 3 is a flow chart illustrating a process for human resources capacity planning for new opportunities in a CRM system. Beginning in block 310, a new business opportunity is input into the CRM application and in block 320, data pertinent to the new business opportunity is extracted therefrom. In block 330, the human resources requirements for the new business opportunity are determined based upon the extracted data, for example by way of a look up to a pre-stored table of human resources requirements keyed on the extracted data. Alternatively, the human resources requirements are generated by application of a rule to the extracted data. In particular, the human resources requirements may be specified in terms of a set of individuals registered in the CRM application, or a set of roles fulfilled by different individuals registered in the CRM application. The human resources requirements also may include a specification of a number of hours of a particular duration of time required for each individual or role in the set.

In block 340, a real time pool of human resources for the CRM application is retrieved specifying individuals, roles or both and the corresponding availability. For instance, the real time pool may express for each individual of associated role or roles a number of free hours over a particular duration of time. As well, the real time pool may express a particular date when additional hours are expected to become available for one or more of the individuals. Thereafter, in block 350 the real time pool is compared to the human resources requirements in order to determine in block 360 if adequate human resources exists to properly service the new business opportunity. More particularly, for each human resource required, the number of hours and duration of time required can be compared to a corresponding available human resource of same identity or same role in order to determine if the requisite number of hours for the requisite duration of time exists. Finally, the determination is presented in a user interface to the end user so that the end user can properly assess whether or not the new business opportunity may be effectively serviced without squandering the new business opportunity.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for human resources capacity planning for new opportunities in a customer relationship management (CRM) system, comprising:
defining a business opportunity in a data structure in memory of a host computing system in which a CRM application executes, the business opportunity comprising data specifying an identity of a prospective customer, an identity of a prospective sale to the prospective customer and a date on which the business opportunity is created;
determining from the data, by a processor of the host computing system, required human resources to support the business opportunity;
loading into the memory of the host computing system from a data store of the CRM application a real time pool of available human resources;
comparing in the memory of the host computing system the required human resources to the real time pool in order to compute whether or not the required human resources are available for assignment to the business opportunity; and
displaying in a user interface to the CRM application an indication of whether or not the required human resources are available for assignment to the business opportunity.

2. The method of claim 1, wherein the required human resources are specified in terms of different required roles and wherein each of the available human resources in the pool are associated with a particular role.

3. The method of claim 1, wherein the required human resources are heuristically determined based upon past utilization of human resources for past processing of business opportunities in the CRM application.

4. The method of claim 1, wherein in response to a determination that the required human resources are not available for assignment to the business opportunity, estimating a date when the required human resources are likely to be available for assignment to the business opportunity and including the estimated date in the user interface.

5. A customer relationship management (CRM) data processing system configured for human resources capacity planning for new opportunities, the system comprising:
a host computing system comprising one or more computers each with memory and at least one processor;
a CRM application executing in the host computing system; and,
a human resources capacity planning module coupled to the CRM application, the module comprising program code enabled upon execution in the host computing system to define a business opportunity in a data structure, the business opportunity comprising data specifying an identity of a prospective customer, an identity of a prospective sale to the prospective customer and a date on which the business opportunity is created, to determine from the data required human resources to support the business opportunity, to load into the memory of the host computing system from a data store of the CRM application a real time pool of available human resources, to compare in the memory of the host computing system the required human resources to the real time pool in order to compute whether or not the required human resources are available for assignment to the business opportunity and to display in a user interface to the CRM application an indication of whether or not the required human resources are available for assignment to the business opportunity.

6. The system of claim 5, wherein the required human resources are specified in terms of different required roles and wherein each of the available human resources in the pool are associated with a particular role.

7. The system of claim 5, wherein the required human resources are heuristically determined based upon past utilization of human resources for past processing of business opportunities in the CRM application.

8. The system of claim 5, wherein in response to a determination that the required human resources are not available for assignment to the business opportunity, estimating a date when the required human resources are likely to be available for assignment to the business opportunity and including the estimated date in the user interface.

9. A computer program product for human resources capacity planning for new opportunities in a customer relationship management (CRM) system, the computer program product comprising a computer readable storage medium having program instructions embodied therewith, the program instructions executable by a device to cause the device to perform a method comprising:
defining a business opportunity in a data structure in memory of a host computing system in which a CRM application executes, the business opportunity comprising data specifying an identity of a prospective customer, an identity of a prospective sale to the prospective customer and a date on which the business opportunity is created;
determining from the data, by a processor of the host computing system, required human resources to support the business opportunity;
loading into the memory of the host computing system from a data store of the CRM application a real time pool of available human resources;
comparing in the memory of the host computing system the required human resources to the real time pool in order to compute whether or not the required human resources are available for assignment to the business opportunity; and
displaying in a user interface to the CRM application an indication of whether or not the required human resources are available for assignment to the business opportunity.

10. The computer program product of claim 9, wherein the required human resources are specified in terms of different required roles and wherein each of the available human resources in the pool are associated with a particular role.

11. The computer program product of claim 9, wherein the required human resources are heuristically determined based upon past utilization of human resources for past processing of business opportunities in the CRM application.

12. The computer program product of claim 9, wherein in response to a determination that the required human resources are not available for assignment to the business opportunity, estimating a date when the required human resources are likely to be available for assignment to the business opportunity and including the estimated date in the user interface.
